(19) United States
(12) Patent Application Publication
(10) Pub. No.: US 2016/0193705 A1
(43) Pub. Date: Jul. 7, 2016

(54) Wheel Rim Positioning Device

(71) Applicant: Factory Automation Technology CO.,LTD., Chiayi County (TW)

(72) Inventors: PO CHENG SU, Chiayi County (TW); KU TANG CHOU, Chiayi County (TW)

(21) Appl. No.: 14/987,730

(22) Filed: Jan. 4, 2016

(30) Foreign Application Priority Data
Jan. 5, 2015 (TW) 104200079

(51) Int. Cl. B23Q 3/06; B60B 30/06; B23Q 3/18

(52) U.S. Cl. CPC B23Q 3/062; B23Q 3/183; B60B 30/06

(57) ABSTRACT

A wheel rim positioning device for positioning a wheel rim being processed includes a supporting base to affixedly set a wheel rim and a flexibly extensible top shore positing part mounted at the central portion of the supporting base, wherein as the wheel rim is set on the supporting base, the top shore positing part will extensibly shore and radially position the wheel rim, wherein a flexible extending movement of the top shore positing part allows the wheel rim positioning device to adapt to match and use wheel rims with various specifications to achieve the result of increasing production efficiency.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a wheel rim positioning device and, in particular, to a wheel rim positioning device which has a flexibly extensible top shore and is able to radially position wheel rims with various specifications.

2. Description of Related Arts

The process of creating an automobile wheel rim mainly relies on automatic wheel rim processing machine to conduct boring and trimming. As a wheel rim is being bored, the wheel rim will be clamped and moved to a set position on a positioning device, so as to be bored by a cutting knife tool. Referring to FIG. 1, as a wheel rim 1 is set on a base 21 of a positioning device 2, a clamp arm 22 of the positioning device 2 clamps against an outer edge of the wheel rim 1. Meanwhile, a center hole 11 of the wheel rim 1 is pushed by a top shore rod 23 of the positioning device 2, so as to securely position the wheel rim 1 at a particular position on the base 21. Although a top shore rod 23 is able to achieve the purpose of top shoring to radially position the wheel rim 1, however it is still inconvenient for real operations because the specification of the top shore rod 23 has to fit a particular wheel rim 1; that is to say, if the size of the center hole 11 of the wheel rim 1, the thickness of the spoke 12, or the height of the wheel rim 1 is different for a different wheel rim, the top shore rod 23 has to be replaced into a suitable position to conduct the processing of the wheel rim 1 each time a different wheel rim is processed, which delays the process and decreases the production efficiency of producing different wheel rims.

### SUMMARY OF THE PRESENT INVENTION

Therefore, an object of the present invention is to provide a wheel rim positioning device 3 which can increase the production efficiency to produce dissimilar wheel rims.

Accordingly, the wheel rim positioning device of the present invention for positioning a wheel rim being processed wherein the wheel rim positioning device has a supporting base to affixedly set a wheel rim and a flexibly extensible top shore positing part mounted at a central portion of the supporting base, wherein as the wheel rim is set on the supporting base, the top shore positing part will extensibly shore and radially position the wheel rim; wherein a flexible extending movement of the top shore positing part allows the wheel rim positioning device to adapt to match and use wheel rims with various specifications to achieve the result of increasing production efficiency.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional perspective drawing of a wheel rim assembled on a positioning device of prior art.

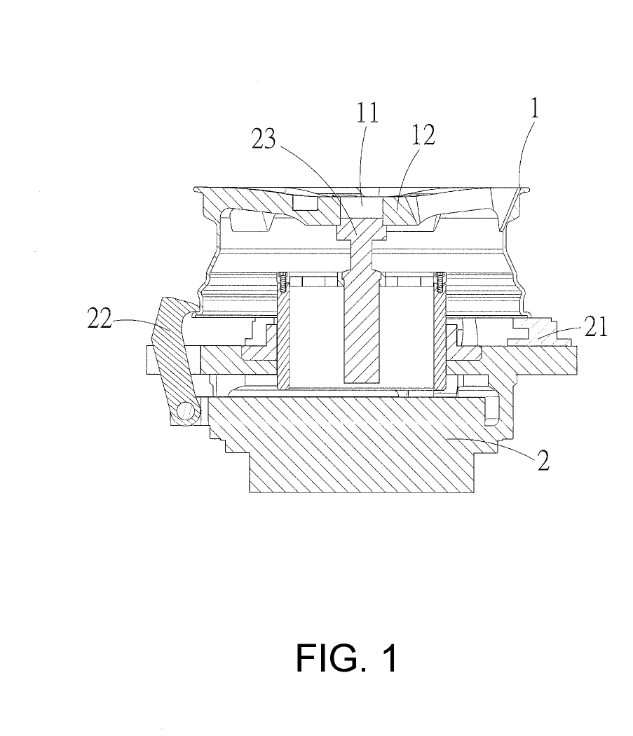

FIG. 2 is a three-dimensional perspective drawing of the wheel rim positioning device according to a preferred embodiment of the present invention.

FIG. 3 is a partially exploded view of the wheel rim positioning device according to a preferred embodiment of the present invention.

FIG. 4 is a sectional perspective drawing of the wheel rim positioning device about to assemble a wheel rim according to a preferred embodiment of the present invention.

FIG. 5 is a sectional view of the wheel rim positioning device assembling a wheel rim according to a preferred embodiment of the present invention.

FIG. 6 is a sectional view of the wheel rim positioning device assembling a wheel rim according to a preferred embodiment of the present invention, illustrating how the mushroom head attaches against a smaller center hole of the wheel rim.

FIG. 7 is a sectional view of the wheel rim positioning device assembling a wheel rim according to a preferred embodiment of the present invention, illustrating how the mushroom head attaches against a larger center hole of the wheel rim.

FIG. 8 is a sectional view of the wheel rim positioning device assembling a wheel rim according to a preferred embodiment of the present invention, illustrating how the mushroom head attaches against a thicker spoke portion.

FIG. 9 is a sectional view of the wheel rim positioning device assembling a wheel rim according to a preferred embodiment of the present invention, illustrating how the mushroom head attaches against a smaller level sized ring portion.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

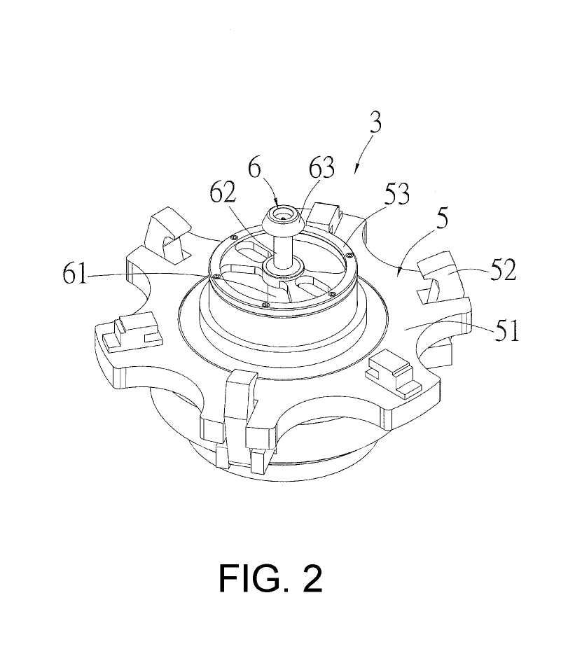

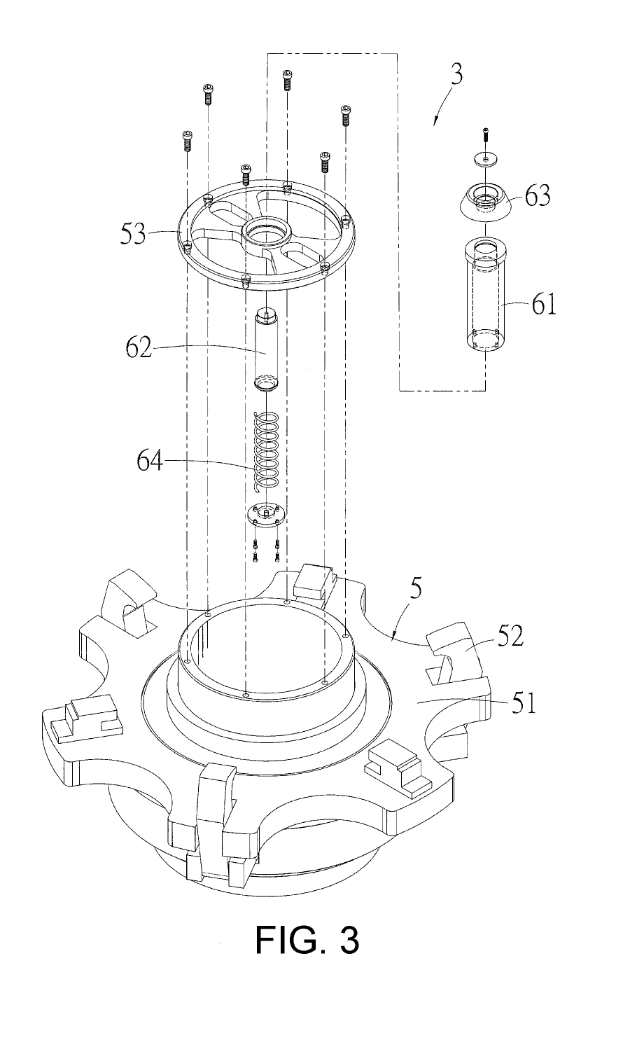

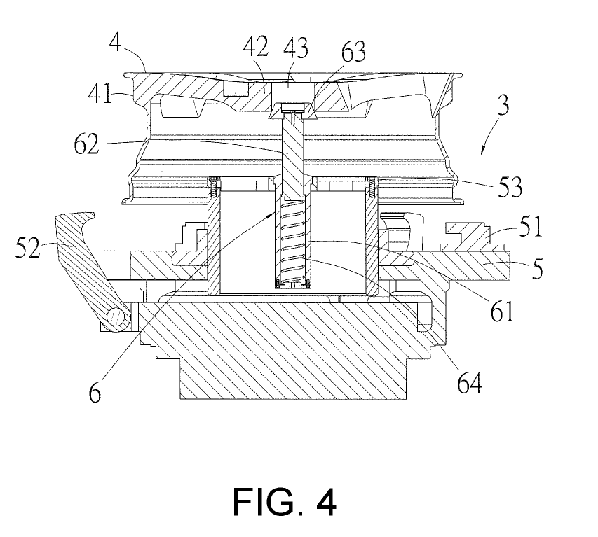

Referring to FIGS. 2-4, a wheel rim positioning device 3 of a preferred embodiment of the present invention is to position a wheel rim 4 being processed, wherein the wheel rim 4 comprises a ring portion 41, a spoke portion 42 extended from the ring portion 41, and a center hole 43 formed in the center of the spoke portion 42, wherein the wheel rim positioning device 3 comprises a supporting base 5 and a top shore positing part 6 mounted in a central portion of the supporting base 5, wherein the supporting base 5 comprises a base body 51, more than one pivotally drivable clamp arms 52 set around the base body, and a mounting portion 53 upwardly protruded from a central portion of the base body 51. The top shore positing part 6 comprises an accommodating tube 61 passingly set on the mounting portion 53, a crown bar 62 extendably moveably passingly set in the accommodating tube 61, a mushroom head 63 affixedly locked at an end of the crown bar 62 that is protruded from the accommodating tube 61, and a resilience part 64 accommodated in the accommodating tube 61 and shored between the accommodating tube 61 and the crown bar 62, wherein the mushroom head 63 is able to push against the center hole 43 of the wheel rim 4 to radially position the wheel rim 4; wherein as the mushroom head 63 is pushed against the center hole 43, the crown bar 62 can flexibly move in relation to the accommodating tube 61 to keep the mushroom head 63 touching against the wheel rim 4 with the flexibility of the resilience part 64.

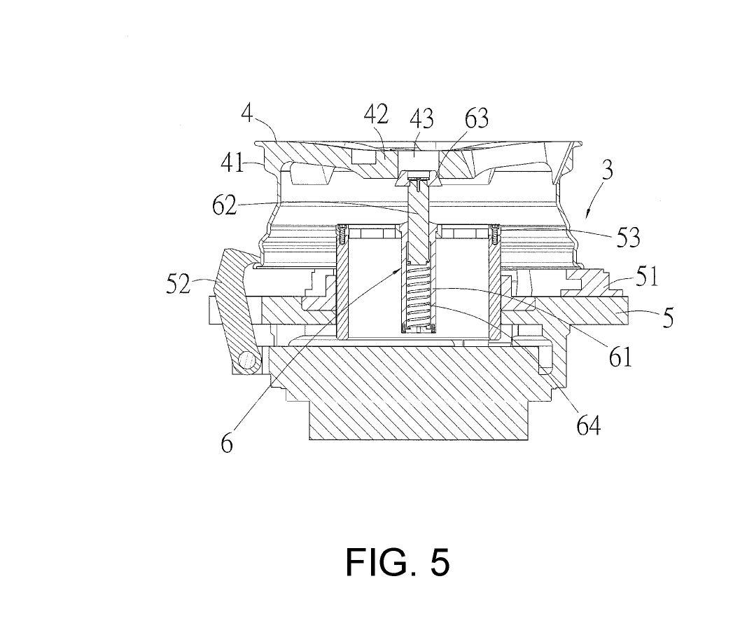

Referring to FIG. 5, as the wheel rim 4 is mounted on the wheel rim positioning device 3, the mushroom head 63 of the top shore positing part 6 is touching against the center hole 43 of the wheel rim 4 and pushed by the spoke portion 42, such that the crown bar 62 draws back to the inside of the accommodating tube 61 to push the resilience part 64. As the ring portion 41 of the wheel rim 4 touches the base body 51, the clamp arm 52 will clamp on the ring portion 41 at the same time, which completes the holding positioning of the wheel rim 4. As for mechanisms of driving the clamp arm 52 to move, it is not a feature of the present invention and therefore will not be described herein.

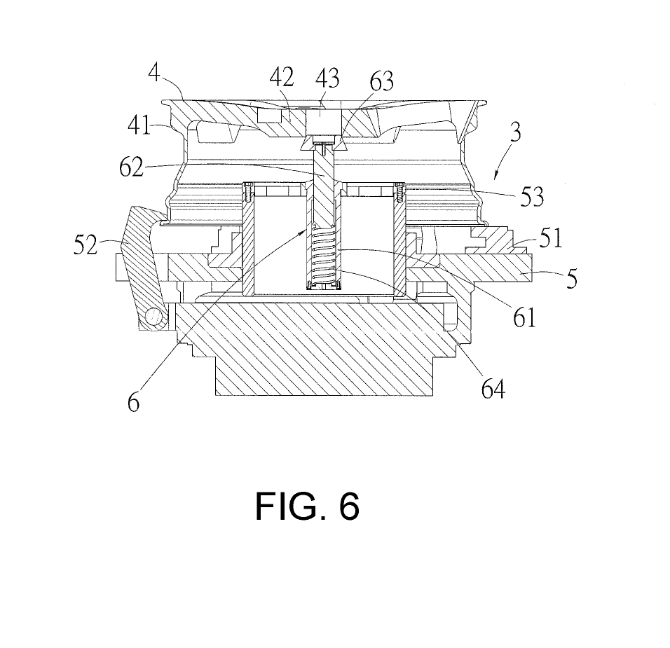

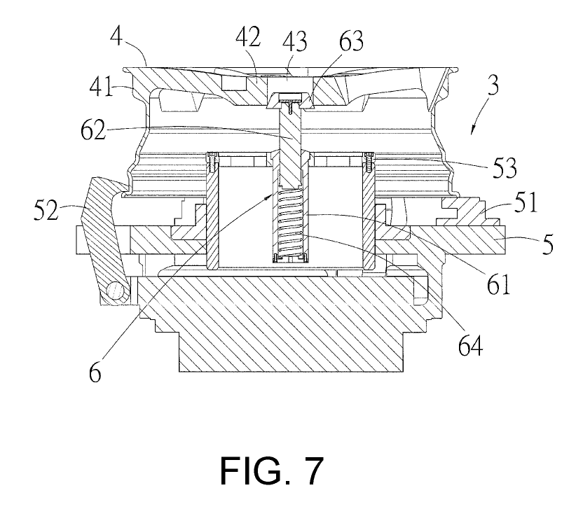

The wheel rim positioning device 3 of the present invention provides holding positioning for the boring process of the spoke portion 42 of the wheel rim 4 to help the processing knife tools (not shown in the drawings) to process the wheel rim 4. Because the top shore positing part 6 has a design of the mushroom head 63, the wheel rim positioning device 3 of the present invention is able to operate with wheel rims with various specifications of the center hole 43. For example, FIGS. 6 and 7 respectively show how the mushroom head 63 pushes against the wheel rim 4 when the center hole 43 of the wheel rim 4 is larger or smaller. That is to say, the wheel rim positioning device 3 of the present invention can work with the wheel rim 4 with various sizes of center hole 43 and when the mushroom head 63 pushes against the center hole 43, the wheel rim 4 has done the positioning of the central point thereof. It is worth mentioning that the mushroom head 63 may also be detached and replaced from the crown bar 62. For example, if the mushroom head 63 has been used for a while and shown abrasion, it can be replaced.

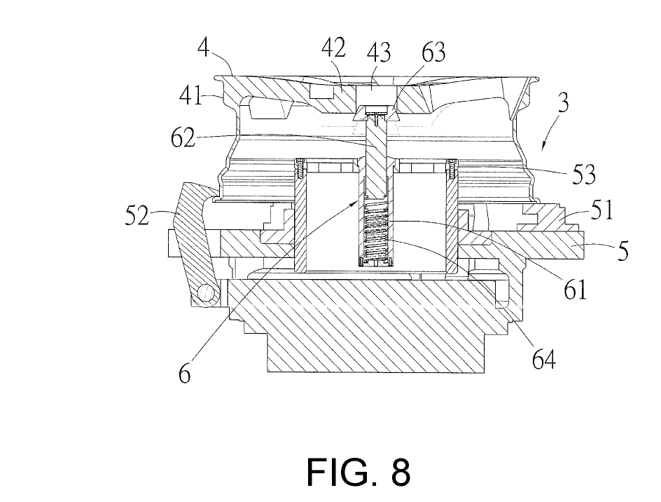

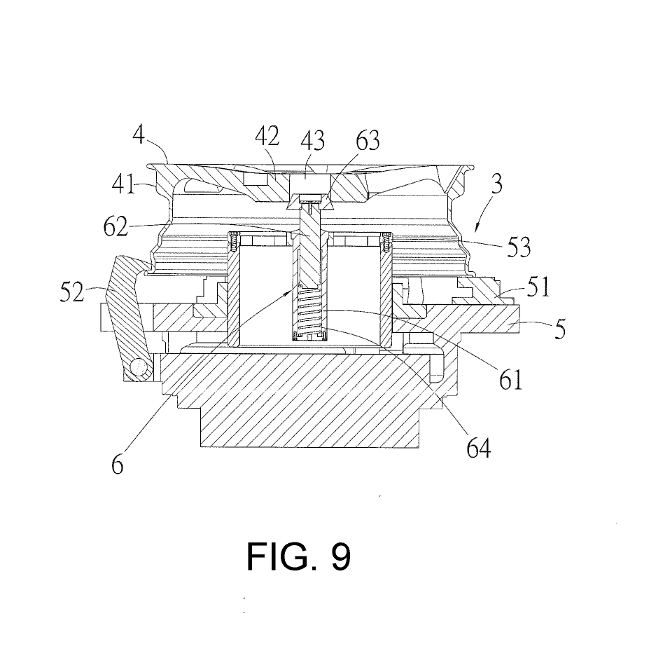

Besides, the design of allowing the crown bar 62 of the top shore positing part 6 to flexibly extensibly move in relation to the accommodating tube 61 also allows the wheel rim positioning device 3 of the present invention to suitably work with wheel rims with various specifications. For the example shown in FIG. 8, as the thickness of the spoke portion increases to the imaginary line, the mushroom head 63 and the crown bar 62 are able to be pressed downward to move down. For another example shown in FIG. 9, as the level size of the ring portion 41 of the wheel rim 4 decreases, the top shore positing part 6 may also shoringly position the wheel rim 4 timely. Therefore, the wheel rim positioning device 3 of the present invention can certainly position wheel rims with various specifications through the flexibly extensibility of the top shore positing part 6 and the design of the mushroom head 63 thereof, so as to achieve the result of increasing production efficiency.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wheel rim positioning device for positioning a wheel rim being processed, comprising a supporting base to affixedly set a wheel rim and a flexibly extensible top shore positing part mounted at the central portion of said supporting base, wherein as said wheel rim is set on said supporting base, said top shore positing part will extensibly shore and radially position said wheel rim.

2. The wheel rim positioning device according to claim 1, wherein said wheel rim has a center hole; said top shore positing part has a mushroom head, wherein said mushroom head touches against said center hole of said wheel rim when said top shore positing part is positioning said wheel rim on said supporting base.

3. The wheel rim positioning device according to claim 2, wherein said top shore positing part further comprises an accommodating tube set in the center of said supporting base, a crown bar extendably moveably passingly set in said accommodating tube, and a resilience part accommodated in said accommodating tube and shored between said accommodating tube and said crown bar, wherein said mushroom head is affixedly locked at an end of said crown bar that is protruded from said accommodating tube.

4. The wheel rim positioning device according to claim 3, wherein said supporting base comprises a base body, more than one pivotally drivable clamp arm set around said base body, and a mounting portion upwardly protruded from the central portion of said base body; said clamp arm allowing clamping against the outer edge of said wheel rim; and said mounting portion allows said accommodating tube to set through.
